(19) United States
(12) Patent Application Publication
(10) Pub. No.: US 2007/0111679 A1
(43) Pub. Date: May 17, 2007

(54) Method and apparatus for vector signal processing

(76) Inventors: Bruce M. Thompson, Boca Raton, FL (US); Leng H. Ooi, Plantation, FL (US); Robert E. Stengel, Pompano Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/280,626

(22) Filed: Nov. 16, 2005

(51) Int. Cl. H04B 1/04

(52) U.S. Cl. 455/114.1

(57) ABSTRACT

A vector signal processor (80) can include a digital to time converter (DTC), an RF memory (RFM) or an electronically tunable transmission line (ETTL) (82), a mixer, or other phase shifter (70) for receiving an output of the DTC or the ETTL, and a controller for selectively controlling the harmonic processing of the DTC, RFM or the ETTL and the phase processing of the mixer. The vector signal processor can uncouple a relative phase of a fundamental signal with respect to harmonics of the fundamental signal. The vector signal processor uses selective phase processing of the fundamental signal and related harmonic components. In a specific embodiment, the vector signal processor cancels harmonics of the fundamental signal and more specifically can cancel a third harmonic of the fundamental signal.

### FIELD OF THE INVENTION

This invention relates generally to vector processing, especially phase processing, and more particularly to a method and system using phase processing to eliminate or reduce harmonics.

### BACKGROUND OF THE INVENTION

Techniques presently in common use for harmonic termination rely on balancing for differential amplifier even harmonic termination, but still must use passive networks for suppressing the odd harmonics. Single ended circuits use fixed passive networks for both even and odd order harmonic termination. Sometimes these fixed passive harmonic terminations are in the form of filters or matching networks. Electronic frequency agile tuning is not possible with these fixed passive networks and circuits.

### SUMMARY OF THE INVENTION

Embodiments in accordance with the present invention can utilize the different phase processing of an electronically tunable transmission line, an RF memory, or digital-to-time converter and the phase processing of a mixer to uncouple the phase relationship between the fundamental and an even or odd harmonic such as the third harmonic. With respect to the third harmonic, it can be said that the fundamental and the third harmonic are no longer tidally locked to the 3Fo relationship which enables the cancellation of the 3rd harmonic and the constructive combining of desired fundamental signals.

In a first embodiment of the present invention, a vector signal processor can include a synthesizer having a digital to time converter (DTC), an RF memory (RFM), or an electronically tunable transmission line (ETTL), a mixer for receiving an output of the DTC, RFM or the ETTL, and a controller for selectively controlling the harmonic processing of the DTC, RFM, or the ETTL and the phase processing of the mixer. A DTC is a radio frequency function where the same time (not phase) delay is applied to all frequency components. An ETTL is an electronically tuned transmission line that has the same radio frequency function as a DTC. A mixer is a radio frequency function where the same phase shift is applied to all frequency components of a signal. The vector signal processor can uncouple a relative phase of a fundamental signal with respect to harmonics of the fundamental signal. The vector signal processor exploits the phase processing of a DTC, RFM or ETTL and the different phase processing of a mixer or traditional phase shifter. Two or more processor outputs may be combined to obtain a composite output signal. In a specific embodiment, the vector signal processor pair cancels harmonics of the fundamental signal and more specifically can cancel an odd harmonic (such as a third harmonic) of the fundamental signal.

In a second embodiment of the present invention, a distributed power amplifier can include a plurality of sections. Each section can include a digital-to-time converter (DTC), RF memory (RFM), or an electronically tunable transmission line (ETTL) having selective phase control, a mixer receiving an output of the DTC, RFM or ETTL, and a baseband phase shift control input to the mixer where the mixer phase response is selectively controlled, and/or a driver amplifier using an output of the mixer as an input signal. The distributed power amplifier can further include a controller for selectively controlling a harmonic processing of the DTC, RFM, or ETTL and for controlling the phase processing of the mixer. The distributed power amplifier can utilize the individual vector processed composite signal as an input to each distributed section. The vector processed composite signals for each section can be combined in the distributed power amplifier output coupling network to provide for in-phase power combining of the desired fundamental signals and the phase cancellation of the undesired harmonics. The distributed power amplifier can cancel harmonics of the fundamental signal and in one specific embodiment cancels a third harmonic of the fundamental signal. Further note, the plurality of sections of the distributed power amplifier can be combined.

In a third embodiment of the present invention, a method of vector signal processing can include the steps of selectively phase modulating signal components of a reference signal, mixing the signal components with selectively chosen phase shifted signal components of a second signal or a plurality of signals, to vector combine the plurality of phase processed signals. The method can further include the step of uncoupling the relative phase of a fundamental signal with respect to harmonics of the fundamental signal. The method can use the spectrum of the fundamental signal for harmonic phase processing and phase processing of the reference signal. The method can further cancel a harmonic of the fundamental signal and in one particular embodiment it can further cancel a third harmonic of the fundamental signal.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a transmitter and distributed power amplifier which operates using the vector signal processing in accordance with the present invention.

FIG. 2 is a representation of the current sources in a multi-section distributed amplifier in accordance with an embodiment of the present invention.

FIG. 3 is a vector representation with associated phase offsets or having exponential terms that have a phase offset term and a frequency term normalized out in accordance with an embodiment of the present invention.

FIG. 4 illustrates the combining of two signals at a single node from neighboring sections of a multi-section distributed amplifier where two currents are represented as vectors with associated phase offsets, or represented as an exponential that has a phase offset term and a frequency term normalized out all in accordance with an embodiment of the present invention.

FIG. 5 is a diagram illustrating the decomposition into sine components for a first seven harmonics in a square wave (with even harmonics being zero) representative of the output of a DTC, RFM or ETTL in accordance with an embodiment of the present invention.

FIG. 6 is a series of diagrams of multiple DTCs, RFMs or ETTLs illustrating the relative phase shifts between them of a fundamental and a third harmonic in accordance with an embodiment of the present invention.

FIG. 7 is a block diagram of a mixer used in accordance with an embodiment of the present invention.

FIG. 8 is a block diagram of a combined DTC or ETTL and mixer used in accordance with an embodiment of the present invention.

FIG. 9 is a vector combiner block diagram for suppression of a third harmonic in accordance with an embodiment of the present invention.

FIG. 10 is another vector combiner block diagram for suppression of a third harmonic in accordance with an embodiment of the present invention.

FIG. 11 is a flow chart illustrating a method of vector signal combining in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

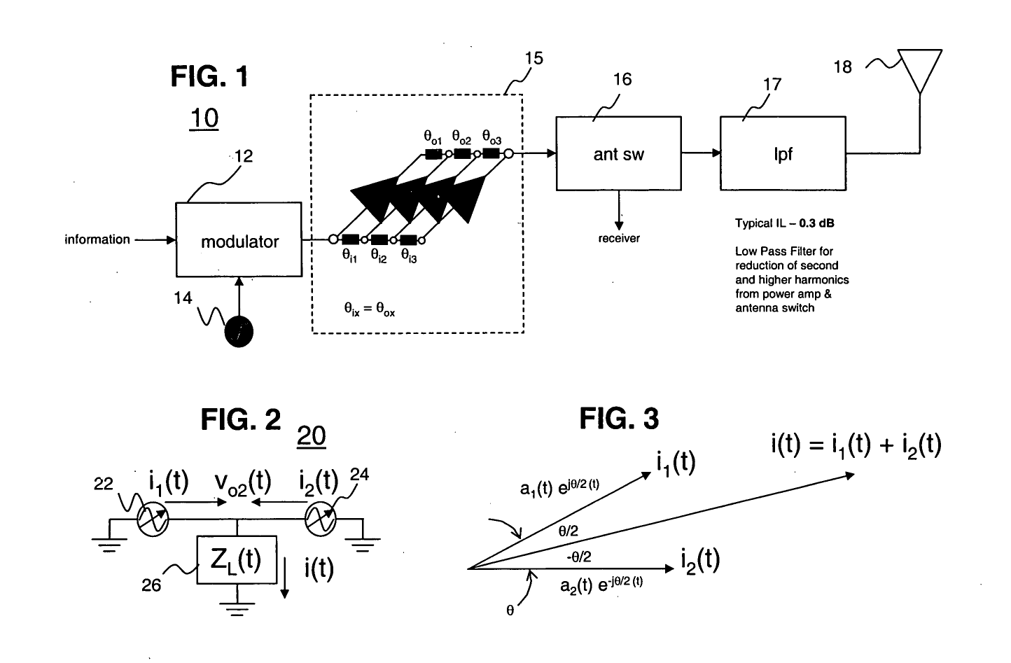

Referring to FIG. 1, a transmitter unit 10 is shown including components typically found in a base transmitter (such as a modulator 12, local oscillator 14, antenna switch 16, low pass filter (LPF) 17 and antenna 18) except that it further includes a distributed power amplifier (DPA) 15. Harmonics generated in the PA must be suppressed. The low pass filter is typically used for reduction of second and higher harmonics from the power amplifier. The typical low pass filter has an insertion loss of 0.3 dB, but a fixed frequency low pass filter is in this regard not suitable for Software Defined Radio (SDR) applications. Using the vector processing technique of this invention, the 0.3 dB low pass filter insertion loss can be absorbed in the power amplifier and the LPF eliminated. A conventional DPA has flat frequency response within a broad active amplification bandwidth. Thus, an electronically tunable, frequency-agile method of suppressing or eliminating harmonics and other undesired signals, much like an LPF currently does (but for different frequencies as opposed to an LPF that has only a fixed frequency corner), would enable frequency agile tuning with spurious signal suppression and undesired spectral component cancellation.

Signals expressed as sinusoids in exponential form illustrate signal combining.:

First the most general form:
S₁(t)=A₁(t)e^{j(ωt+φ}^{₁}⁾
has an amplitude term, a frequency term, a phase term.
In the second line: =A₁(t)e^{jωt}e^{jφ}^{₁}
the frequency and phase terms are separated out.
In the next line, we add a second signal, a different amplitude, a different phase, but same frequency: S₂(t)=A₂(t)e^{jωt}e^{jΦ}^{₂}
Now these two signals are added together and the frequency is normalized out: S(t)=[S₁(t)+S₂(t)]/e^{jωt}=A₁(t)e^{jφ}^{₁}+A₂(t)e^{jφ}^{₂}
Now, set the amplitudes equal to one:
A(t)=A₂(t)=1
This is appropriate here since signals from a digital-to-time converter (DTC) or an electronically tunable transmission line (ETTL), for example are robust rail-to-rail, equal amplitude signals.
Now we have one sinusoid: S(t)/e^{jωt}=e^{jφ}^{₁}+e^{jφ}^{₂}
and a square wave in terms of these components:
S_{SQ}(t)=a₁e^{jω}^{₁}^{t+φ}^{₁}+a₃e^{j3ω}^{₁}^{t+3φ}^{₁}+ . . . , for relative square wave.
And its coefficients where aₙ=4/π Σ1/2ₙ₋₁

Referring to a circuit representation 20 of FIG. 2, there are two signals that can be assumed to be from neighboring sections of a multi-section distributed amplifier. They can be two current sources 22 and 24 creating a current i(t) through a load Z(t) 26. Referring to FIG. 3, again, two signals, in this case currents, have can be represented as vectors with associated phase offsets, or represented as an exponential that has a phase offset term and a frequency term normalized out. When normalized, only the phases are left. The resultant current vector then looks like:
i(t)=a₁(t)^{ej}^{^{θ/2(t)}}+a₂(t)e^{-jθ/2(t)} The resultant current vector.
Using Euler's formula for each exponential: (to put in terms of sin and cos)
(t)=a(t)[cos(θ/2)+j sin(θ/2)]+a(t)[cos(−θ/2)+j sin(−θ/2)], for a(t)=a₁(t)=a₂(t)
After combining like terms:.
|i(t)|=2a(t)cos(θ/2), for a(t)=a₁(t)=a₂(t)
Solving for phase shift corresponding 0.3 dB magnitude reduction (the low pass filter loss):
10−((−0.3 dB)/20)=0.966*|i(t)|max=2a(t)cos(θ/2),θ=30 degrees
Clearly, the phase accuracy of the combined signal does not have to be precise. To achieve a combining loss of three tenths of a dB requires only a thirty degree phase matching on desired signals. The vector processing technique of this invention can produce exact cancellation and combining results. However, this 30 degree phase combining window offers additional latitude for cancellation of multiple harmonics simultaneously with no more loss then that of fixed low pass filter.

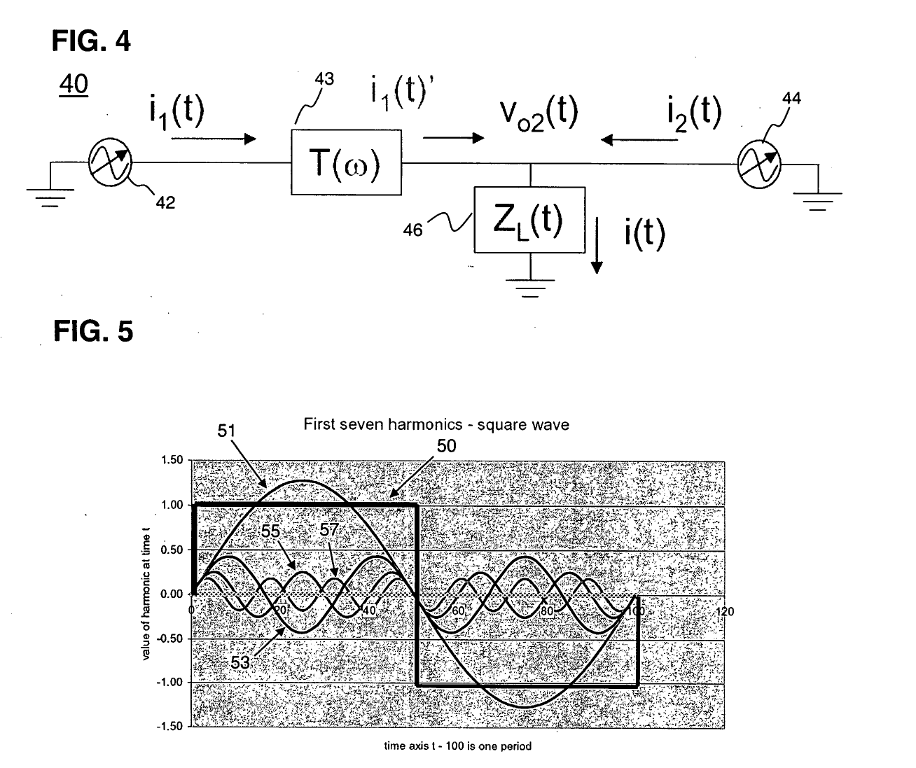

Referring to the circuit representation 40 of FIG. 4, a transformation 43 is inserted on the i₁ current leg (42) leading to the common node V₀₂. This is the complete equation including the ωj term. The i₁ branch current equation then looks like:
i₁(t)=a₁(t)[e^{j(ω}^{₁}^{+T(ω}^{₁}^{))t}+c₃e^{j(ω}^{₃}^{+T(ω}^{₃}^{))t}+c₅e^{j(ω}^{₅}^{+T(ω}^{₅}^{))t}+ . . . ]
The T(ω₁) term is a phase term. There is no frequency or amplitude term there. This shows that the transformation 43 is a lossless phase term in the i1 path. It's a general signal expression with individual phase delays for the frequency components. The odd terms are just shown here.
Assuming the transformation is a simple transmission line:
i₁(t)′=a₁(t)[e^{j(ω}^{₁}^{30 T(ω1))t}+c₃e^{j(ω}^{₃}^{+3T(ω}^{₁}^{))t}+c₅e^{j(ω}^{₅}^{+5T(ω}^{₁}^{))t}+ . . . , for a transmission line.
Note that the phase shift for each frequency component increases with harmonic order.
Now if i₂ (44) is a square wave, then its harmonic phase shifts is similar to a Transmission-line.
i₂(t)=a₂(t)[e^{j(ω}^{₁}^{+θ)t}+c₃e^{j(ω}^{₃}^{+3θ)t}+c₅e^{j(ω}^{₅}^{+5θ)t}+ . . . ], for relative square wave
It's interesting to note that a square wave shifted in time or phase, looks a lot like a transmission line shift. The digital to time converter (DTC), RF memory (RFM) or the electronically tunable transmission line (ETTL) can deliver square waves with harmonic order dependent phase shift for each harmonic signal component.

Referring to FIG. 5, an illustration of a square wave Fourier decomposition into Sine components is shown. Now one can see that the relative phase shift of the harmonic terms is increasing with harmonic order.
S(t)=a₀+a₁e^{j(ω}^{₁}^{t+φ1)}+a₂e^{j(ω}^{₂}^{t+φ2)}+a₃e^{j(ω}^{₃}^{t+φ3)}+ . . .
For a perfect Differential square wave the direct current (DC) term is zero, along with the even order terms in the series. As illustrated, the square wave 50 can be decomposed into Sine components including a fundamental signal 51, a “third harmonic” signal 53, a “fifth harmonic” signal 55, a “seventh harmonic” signal 57 and so on.

With respect to a DTC or ETTL, note that Transmission Lines have fixed electrical lengths. A λ/4 @ 1 GHz line has 90° phase shift at the 1 GHz fundamental and 270° phase shift at the 3 GHz third harmonic. A DTC or ETTL (synthesizer) acts as an electronically tunable Transmission Line in terms of its phase modulation of the generated signal components. Thus:
S_{DTC}(t)=G(a₀+a₁e^{j(ω}^{₁}^{t+φ}^{₁}⁾+a₂e^{j(ω}^{₂}^{t+2φ}^{₁}⁾+a₃e^{j(ω}^{₃}^{t+3φ}^{₁}⁾+ . . . )
The transmission line's third harmonic phase is changing three times faster than the fundamental signal. Phase change is even “faster” for higher harmonics. Therefore, the phase modulation for a DTC or ETTL (or transmission line) synthesizer in this regard is harmonic dependent. The equation also shows even terms which are zero for a balanced differential square wave.

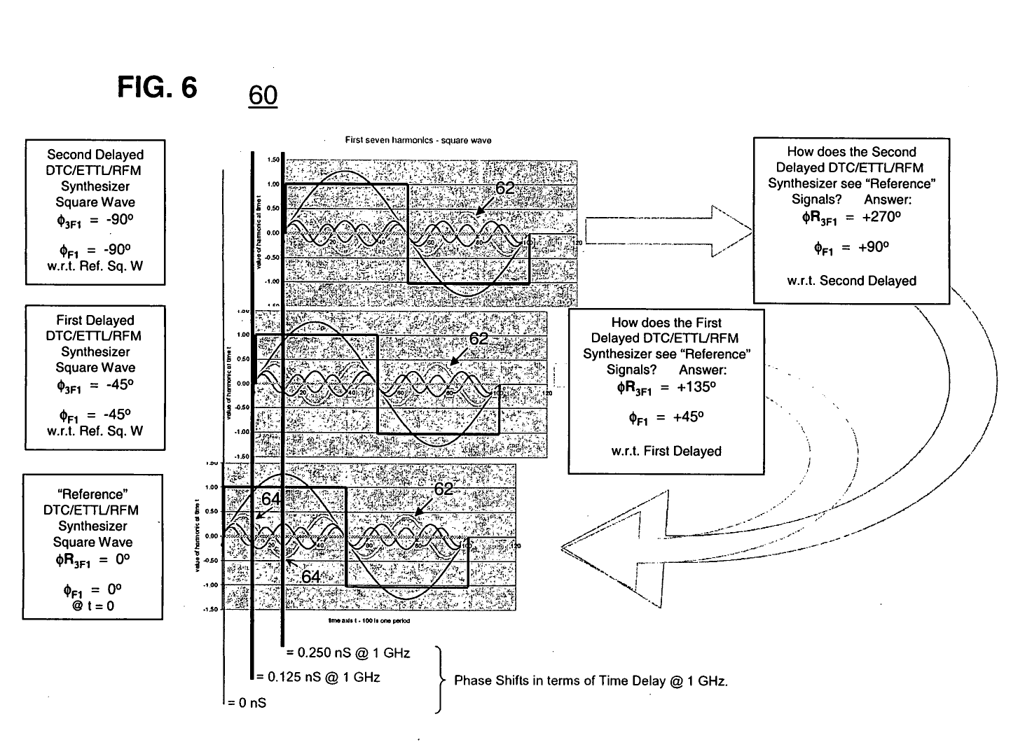

Although the output of the DTC or ETTL is a square wave, it be called an “electronically tunable transmission line” based on the following reasoning. An ETTL or DTC square wave can be delayed, but only as compared to a reference such as another ETTL or DTC output that is un-delayed with respect to it. Referring to the waveforms 60 for the multiple synthesizers and their relative phase shifts between them of the fundamental and third harmonic shown in FIG. 6, if the bottom “reference DTC/ETTL/RFM” synthesizer is started first, putting out a 1 GHz square wave, and the next one up—the “First Delayed DTC/ETTL/RFM” is started 125 pS later, then the frequency components of these square wave trains will have a phase offset corresponding to that time delay, for example 45 degrees at 1 GHz for the fundamental frequency. From the stand point of the “First delayed DTC/ETTL/RFM” synthesizer, the third harmonic component of the “reference DTC/ETTL/RFM” is +135 degrees out of phase, or 3 times the phase shift of the reference fundamental at 1 GHz. Here, the third harmonic is shown as waveform 62. The points 64 indicate the phase for the third harmonic phase on the reference synthesizer with respect to the zero degree starting phase of the “First Delayed DTC/ETTL/RFM” and an additional 45 degrees later—the “Second Delayed DTC/ETTL/RFM”. If 45 degrees (@ 1 GHz) of transmission line were added to the “First delayed DTC/ETTL/RFM's” waveform it would be equivalent to the phase of the “reference DTC/ETTL/RFM”. Note, illustration in FIG. 6 shows several separate Synthesizers, but it could just as well be one synthesizer and several individual tap selectors.

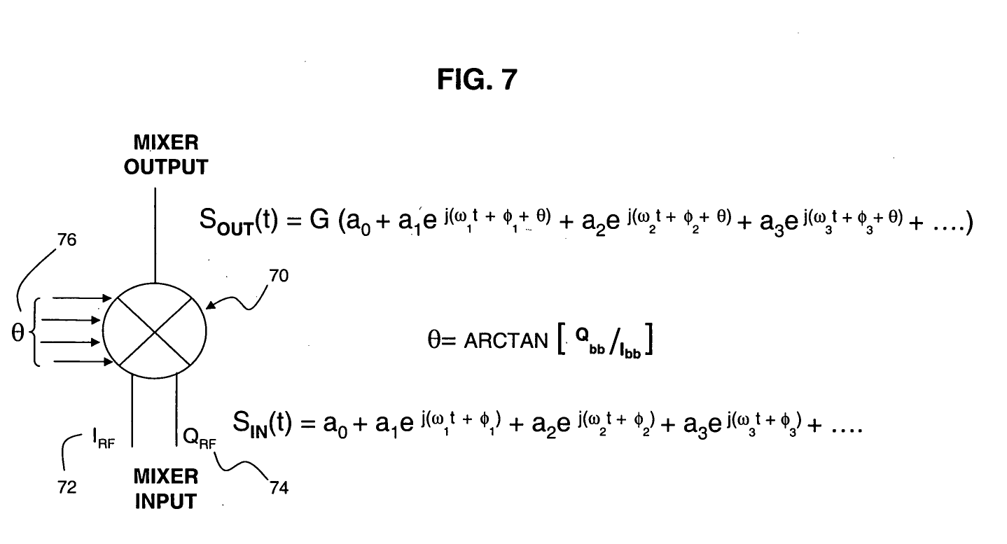

Referring to a mixer 70 of FIG. 7, such mixer has I and Q inputs 72 and 74 respectively and a phase input 76. Mixers add phase shift evenly to all spectral components. Shifting the fundamental by 30 degrees, shifts each of the harmonics by 30 degrees. The phase processing of conventional mixers is a straight multiply. The RF carrier input is from the bottom. Input signals with independent phases for each frequency component can be represented as:
S_{IN}(t)=a₀+a₁e^{j(ω}^{₁}^{t+φ}^{₁}⁾+a₂e^{j(ω}^{₂}^{t+φ}^{₂}⁾+a₃e^{j(ω}^{₃}^{t+φ}^{₃}⁾+ . . .
The phase shift θ=ARCTAN [Q_{bb}/I_{bb}]
Note, here I & Q are DC or baseband inputs coming into 76.
Now the output taken from the top has the evenly distributed phase offset, shown in bold.
S_{OUT}(t)=G(a₀+a₁e^{j(ω}^{₁}^{t+φ1+θ)}+a₂e^{j(ω}^{₂}^{t+φ}^{₂}^{+θ)}+a₃e^{j(ω}^{₃}^{t+φ}^{₃}^{+θ)}+ . . . )
Therefore, the mixer phase modulation is harmonic independent.

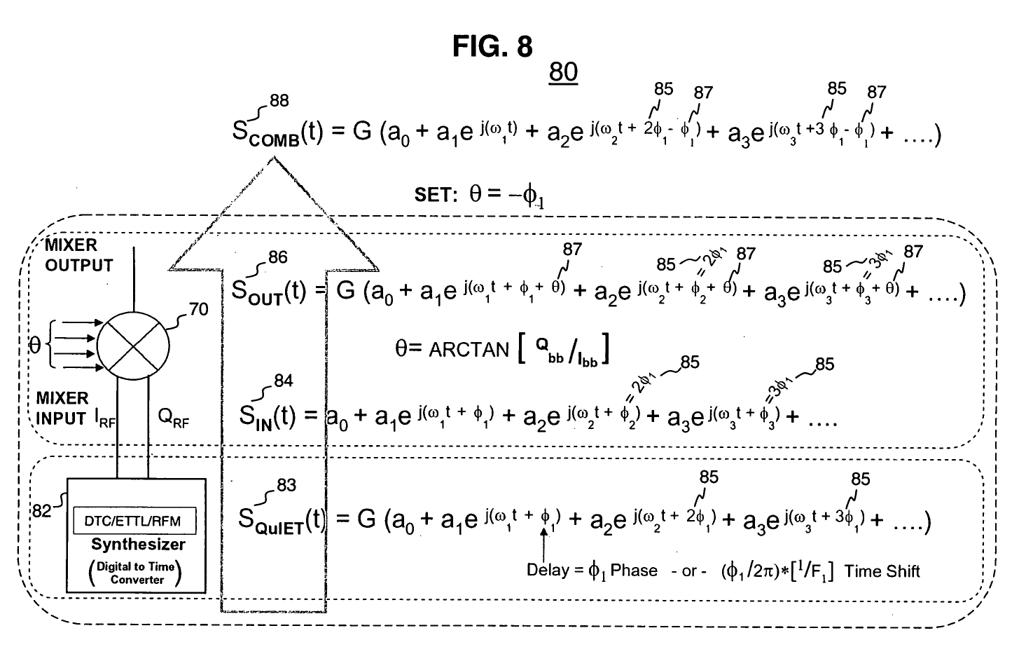

Referring to FIG. 8, a block diagram representation 80 illustrates the combined phase processing of both a (DTC or ETTL or RFM) synthesizer and a mixer. Starting with the bottom block or DTC/ETTL/RFM synthesizer 82, the square wave output from the synthesizer has its harmonic phase shifts linked to harmonic order, i.e. harmonic Dependent phase processing Harmonic phases are shown as item 85 in terms of multiplied fundamental offset. When we progress upward to the mixer 70, that same square wave signal is an input for the mixer harmonic Independent phase processing. Mixer imparted phase shifts are shown as item 87. Controlling these blocks allows for the un-coupling of the phase relationship between the fundamental and its third harmonic. Note, the synthesizer output is represented by equation 83, the mixer input is represented by equation 84, the mixer output is represented by equation 86, and the combined output is represented by equation 88.

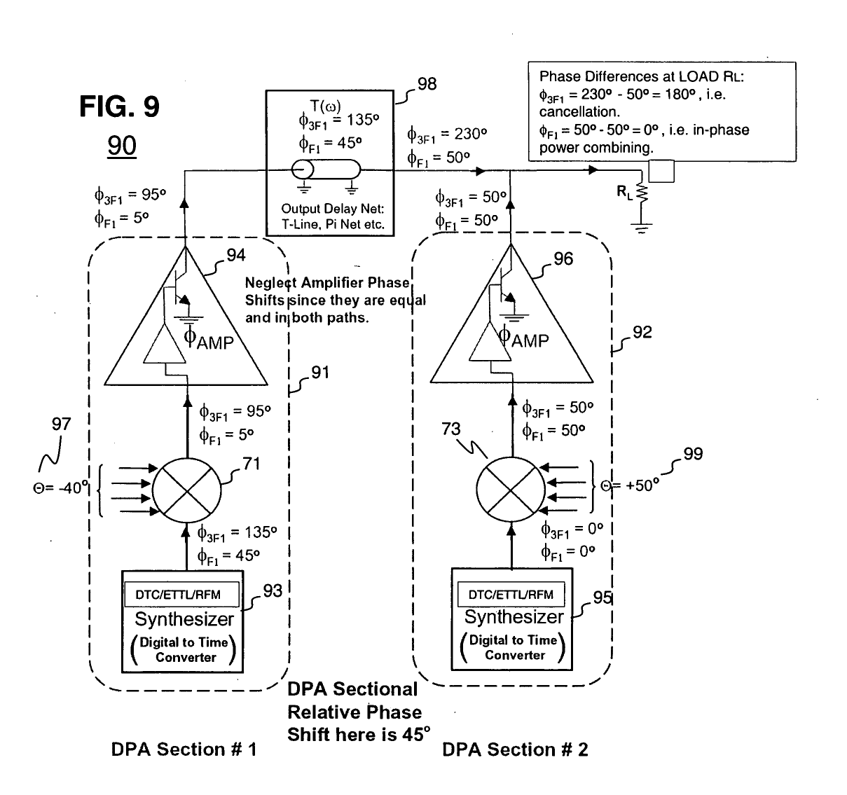

Referring to a doublet 90 of an n section distributed amplifier as represented in FIG. 9 includes a first DPA section 91 having synthesizer portion 93, mixer portion 71, and amplifier 94 and a second DPA section 92 having synthesizer portion 95, mixer portion 73, and amplifier 96. The fundamental at each location is represented as F₁ and the phase of the third harmonic is represented as 3F₁. The approach shown takes advantage of the different phase processing of an electronically tunable transmission line or DTC (i.e., a digital-to-time converter synthesizer in this example) and the phase processing of a mixer to uncouple the phase relationship between the fundamental and the third harmonic. In other words, the fundamental and the third harmonic are no longer tidally locked to 3×. This relationship enables the (perfect) cancellation of the 3rd harmonic and the addition of the desired fundamental perfectly. Combining the signals from the two sections through a conventional distributed amplifier output delay network 98, the phase differences at the load for the undesired third harmonic can be cancelled and in-phase power combining can be achieved at the desired fundamental. The 30 degree signal combining window is not needed, we have perfect cancellation. Here RF current vectors are being used. Where there is cancellation, the current=0, implying an open circuit. An open is the proper termination for the odds from an efficiency point of view.

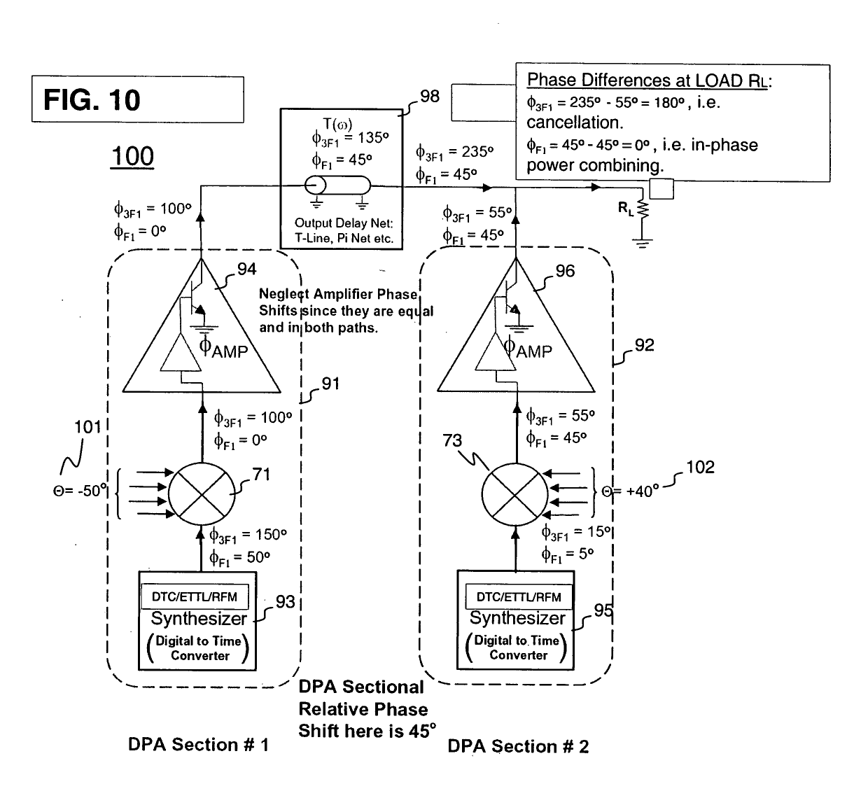

The distributed power amplifier 90 of FIG. 9 included a doublet with DPA sections having phase inputs 97 and 99 to the respective mixer portions 71 and 73. Referring to FIG. 10, the distributed power amplifier 100 includes the same architecture as DPA 90, but has DPA sections having phase inputs 101 and 103 to the respective mixer portions 71 and 73. Note, although the DPA sectional relative phase shift between sections is 45 degrees in each instance, the starting fundamental phase from each doublet (90 or 100) can be quite different and the phase inputs to the mixer portions can be modified based on the different fundamental frequencies to provide the desired results in either case. Further note, the phase offset of the fundamental is now independent of the phase offset of the harmonics. This is no longer a Square Wave. The time wave form out of the synthesizer will still be square but harmonic phases with respect to the reference signal, that is the signal from the next section or mixer, will be altered.

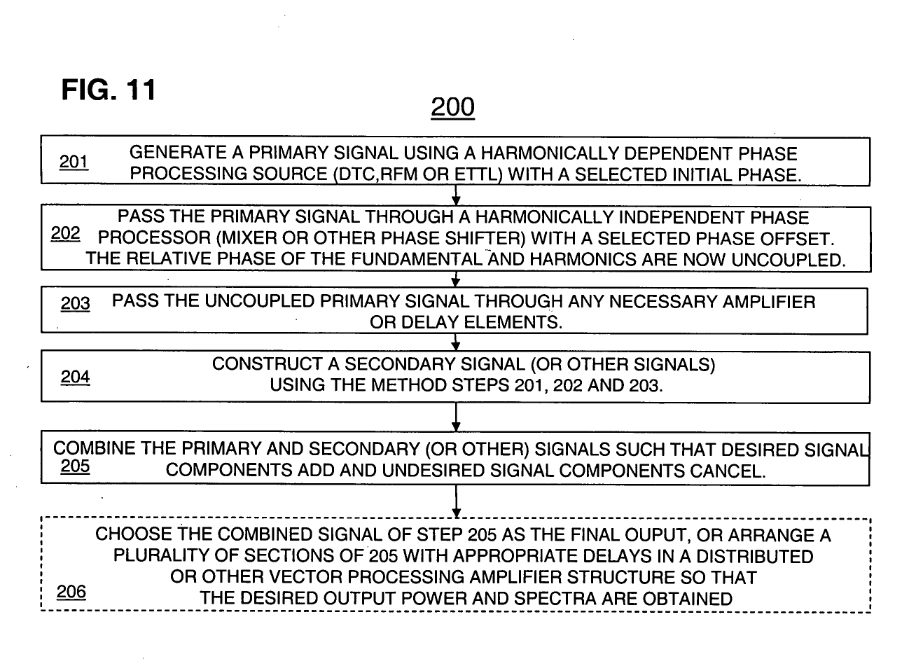

Referring to FIG. 11, a flow chart illustrating a method 200 of vector signal processing can include the step 201 of generating a primary signal using a harmonically dependent phase processing signal source (DTC/ETTL/RFM) with a selected initial phase and the step 202 of passing the primary signal through a harmonically independent phase processor (Mixer of other phase shifter) with a selected phase offset at step 202. Note, the relative phase of a fundamental signal and its harmonics become uncoupled to form an primary signal with the phase relationship of the harmonics and the fundamental uncoupled from simple harmonic order. The method 200 can further include the step 203 of amplifying or delaying the uncoupled primary signal. A secondary signal is constructed at step 204 using the steps 201, 202, and 203 of generating, passing, and amplifying or delaying. Note, with reference to FIGS. 9 or 10, the primary signal can be the output from distributed power amplifier (DPA) Section #1 and the secondary signal can be the output from the DPA Section #2. Method 200 can further include the step 205 of combining the primary signal and at least the secondary signal such that desired signal components add and undesired signal components cancel to form a combined signal. Note, the combined signal is not just limited to the combination of the primary signal and the secondary signal as illustrated, but can include a number of combinations where desired signal components add and undesired signal components cancel generally. A such, the method 200 can chose the combined signal as the final output or form an arrangement of a plurality of sections with appropriate delays in a distributed or other vector processing amplifier structure so that a desired output power and spectra are obtained as noted in step 206.

The step 202 of passing the primary signal through a harmonically independent phase processor can be done through a mixer or other phase shifter with the selected phase offset. In one embodiment, the method can cancel even or odd harmonics of the fundamental signal, or the fundamental itself, as desired and in other particular embodiments a third harmonic of a fundamental signal can be either cancelled or added together (in a tripler). The method enables the selective adding or canceling of a particular harmonic of the fundamental signal as desired. As previously noted, the cancellation of undesired harmonics is not just limited to cancellation of third harmonics or just odd harmonics. The technique demonstrated and claimed herein can also apply to other undesired harmonics including even harmonics.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A vector signal processor, comprising:
a synthesizer including one of: a digital to time converter (DTC), an RF memory (RFM) and an electronically tunable transmission line (ETTL);
a mixer for receiving an output from the one of the DTC, RFM and ETTL; and
a controller for selectively controlling harmonic processing of the one of the DTC, RFM and ETTL and the phase processing of the mixer.

2. The vector signal processor of claim 1, wherein the vector signal processor uncouples a relative phase of a fundamental signal with respect to harmonics of the fundamental signal.

3. The vector signal processor of claim 2, wherein the vector signal processor uses a phase of the fundamental component of the signal for the harmonic phase processing.

4. The vector signal processor of claim 2, wherein the vector signal processor cancels a third harmonic of the fundamental signal.

5. The vector signal processor of claim 1, wherein the vector signal processor further comprises a radio frequency power amplifier.

6. The vector signal processor of claim 1, wherein the vector signal processor cancels harmonics of the fundamental signal.

7. A distributed power amplifier, comprising:
a plurality of sections, each section comprising:
a synthesizer having one of: a digital-to-time converter (DTC), an RF memory (RFM) and an electronically tunable transmission line (ETTL) having selective phase control;
a mixer receiving an output from the one of the DTC,RFM and ETTL;
a phase input to the mixer, wherein the phase input is selectively controlled; and
a power amplifier using an output of the mixer as an input signal.

8. The distributed power amplifier of claim 7, wherein the distributed power amplifier further comprises a controller for selectively controlling a harmonic processing of the synthesizer's DTC, RFM or ETTL and a phase processing of the mixer.

9. The distributed power amplifier of claim 7, wherein the distributed power amplifier uncouples a relative phase of a fundamental component and harmonic component with respect to harmonic order of the original signal.

10. The distributed power amplifier of claim 8, wherein the distributed power amplifier uses a phase of a fundamental signal component for the harmonic processing phase processing.

11. The distributed power amplifier of claim 7, wherein the distributed power amplifier cancels a third harmonic of a fundamental signal.

12. The distributed power amplifier of claim 9, wherein the distributed power amplifier cancels harmonics of the fundamental signal.

13. The distributed power amplifier of claim 7, wherein the plurality of sections of the distributed power amplifier are combined.

14. A method of vector signal processing, comprising the steps of:
generating a primary signal using a harmonically dependent phase processing source with a selected initial phase;
passing the primary signal through a harmonically independent phase processor with a selected phase offset, wherein the relative phase of a fundamental signal and its harmonics become uncoupled to form an uncoupled primary signal;
amplifying or delaying the uncoupled primary signal;
constructing at least a secondary signal using the steps of generating, passing, and amplifying or delaying; and
combining the primary signal and at least the secondary signal such that desired signal components add and undesired signal components cancel to form a combined signal.

15. The method of claim 14, wherein the method further comprises the step of choosing the combined signal as a final output.

16. The method of claim 14, wherein the method further comprises the step of arranging a plurality of sections with appropriate delays in a distributed or other vector processing amplifier structure so that a desired output power and spectra are obtained.

17. The method of claim 14, wherein the step of passing the primary signal is done through a mixer or other phase shifter with the selected phase offset.

18. The method of claim 14, wherein the method further cancels a third harmonic of the fundamental signal.

19. The method of claim 14, wherein the method further cancels an even or odd harmonic of the fundamental signal.

20. The method of claim 14, wherein the method further enables the selective adding of a particular harmonic of the fundamental signal.

21. The method of claim 14, wherein the method further enables the selective cancellation of the fundamental and adding of a particular harmonic of the fundamental signal.
